(19) United States
(12) Patent Application Publication
(10) Pub. No.: US 2008/0255914 A1
(43) Pub. Date: Oct. 16, 2008

(54) System and a Method for Managing Building Projects

(76) Inventor: Shlumi (Shlomo) Oren, Yehood (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/064,657

(22) PCT Filed: Aug. 10, 2006
(86) PCT No.: PCT/IL2006/000933

§ 371 Date: Feb. 25, 2008

(30) Foreign Application Priority Data
Aug. 25, 2005 (IL) 170490

(51) Int. Cl. G06Q 10/00

(52) U.S. Cl. 705/8

(57) ABSTRACT

A system and method for comprehensive data integration and management of large-scale building projects. The building projects comprised of a planning module (100) which supports entrepreneurs's decision making processes by enabling them to compare the costs and resources needed for the planned project according to different scenario plans (105). The second enables a semi-automatic translation of design plans drawings into inventory lists and building tasks (110). The third is a real-time project management module (120) which offers extensive tools for keeping track of projects' progress.

### BACKGROUND

The present invention is a system and a method for comprehensive management of large-scale building projects; more specifically it is a computerized system and method for comprehensive management of large-scale building projects which include semi-automatic integration of images of design drawings.

The ever increasing complexity of large-scale building projects demand that professionals in the building industry find more effective and reliable methods of working. Such building projects demand the coordination and the cooperation of a large number of professionals from a wide variety of fields of expertise. In addition to having architects, engineers, and contractors respond to their clients' requests for building designs, cost estimates, and construction schedules in connection with construction projects, they also need to insure that such information and data is accurate. To remain competitive in today's marketplace, professionals in the building industry also need to dramatically reduce the time it takes to develop the requested information and data, as well as the overall project delivery time, at no expense to the quality of the project or the accuracy of the budget estimate.

Known in the art are several project management tools for aiding project managers of building projects. International Patent Application no. WO0167372, for instance, is a computer-implemented automated building design, modeling, construction project cost estimating and scheduling system. The system provides a central source for all design and construction information for a construction project in a coordinated two- and three-dimensional spatial database that is freely accessible by all members of an interdisciplinary construction project team. The system acquires and stores all appropriate design, engineering and construction expertise and information available for any building type for use in automatically assembling and coordinating the design, cost-estimating, and scheduling for a construction project.

While this tool provides comprehensive project design and management tools, its application relies on having the planning, designing and executing teams use the proposed system's tools. But most professionals are accustomed to working with proprietary tools and are not inclined learn how to work in new environments. More specifically, the designing team has Computer Aided Designing (CAD) applications which are specifically suited for their needs, and each company has its preferred software application.

There is therefore a need for a comprehensive construction management tool which can integrate data from the graphic plans and designs, without having to rely on the project designing teem to work with a specific CAD application. Such a solution would need to analyze data from images of design plans and integrate it into a project management tool.

### BRIEF DESCRIPTION OF THE DRAWINGS

These and further features and advantages of the invention will become more clearly understood in the light of the ensuing description of a preferred embodiment thereof, given by way of example, with reference to the accompanying drawings, wherein—

FIG. 1 is a block diagram of the principal components of the preferred embodiment of the present invention;

FIG. 2 is a block diagram of the Entrepreneurs Project Scenario Tools in accordance with the preferred embodiment of the present invention;

FIG. 3 is a block diagram of the Project Designer Tools in accordance with the preferred embodiment of the present invention;

FIG. 4 is a block diagram of the On Site Project Manager Tools 120 in accordance with the preferred embodiment of the present invention;

FIG. 5 is a block diagram of the components of each module in accordance with the preferred embodiment of the present invention;

FIG. 6 is an illustration of the marking method of the plans of a project in accordance with the preferred embodiment of the present invention;

FIG. 7 is a screenshot illustrating the representation of data which is derived from the marked plans in accordance with the preferred embodiment of the present invention;

FIG. 8 is a second illustration of the marking method of the plans of a project in accordance with the preferred embodiment of the present invention;

FIG. 9 is a screenshot illustrating a Task Report in accordance with the preferred embodiment of the present invention.

### DETAILED DESCRIPTION OF THE PREFERRED EMBODIMENTS

The present invention offers comprehensive tools for managing all stages of large-scale building projects. The disclosed management tools are software applications which allow the user to specify the project requirements for the planning team and translate building plans into the necessary data for managing building projects such as operational tasks, lists of required materials, budget planning and scheduling. The tool also enables keeping track of the project's progress and dynamically updating cost and schedule calculations. Unlike prior art, which may only utilize a specific computer aided design (CAD) application, the disclosed system allows project designers to use any type of designing tool. The system may even integrate scans of hardcopy drawings. The system extracts all necessary information from the design in a semi-automatic manner.

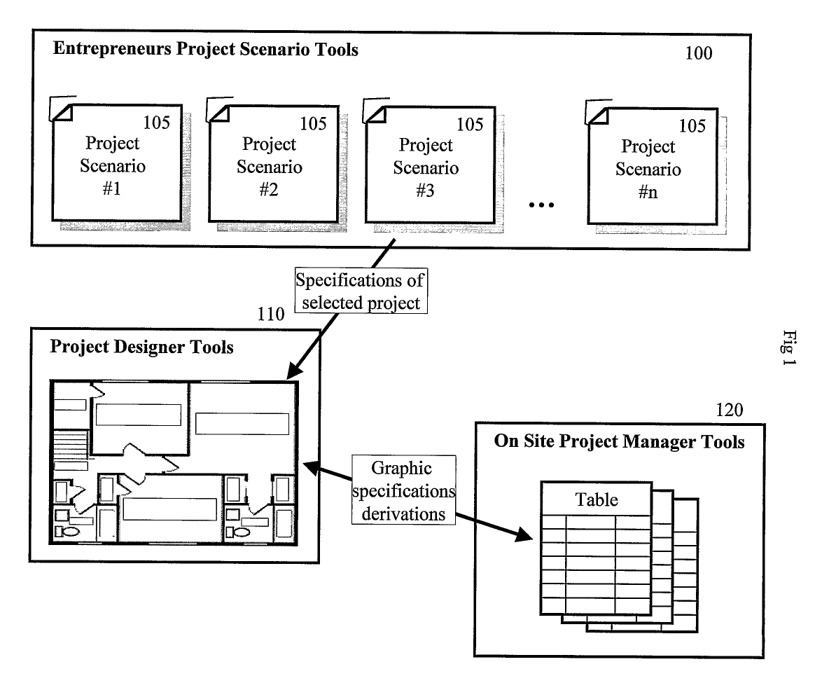

As illustrated in FIG. 1, the tool is comprised of three main components. The first is a planning module 100 which supports entrepreneurs' decision making processes by enabling them to compare the costs and resources needed for the planned project according to different scenario plans 105. The second enables a semi-automatic translation of design plans drawings into inventory lists and building tasks 110. The third is a real-time project management module 120 which offers extensive tools for keeping track of projects' progress, efficiently coordinating operational tasks and materials, and dynamically calculating the projects cost breakdown.

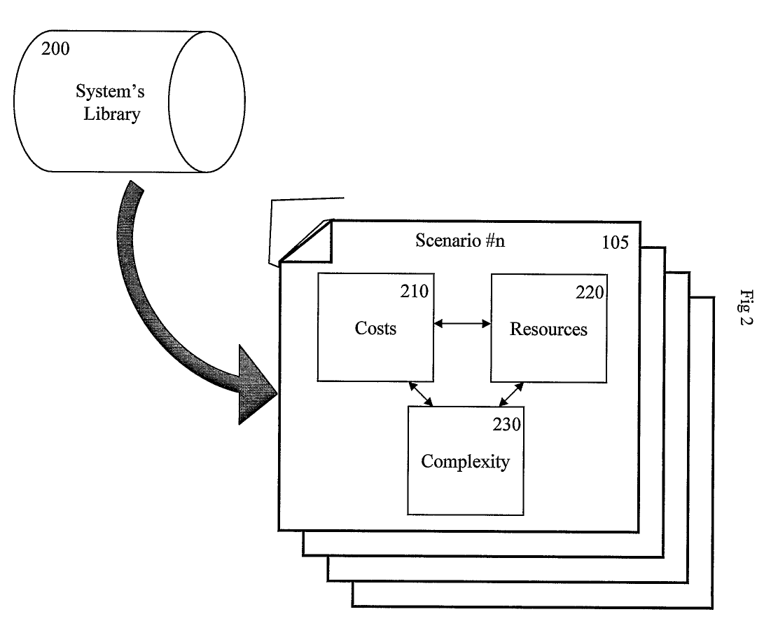

The system supports all the decision making procedures of the planning stages, including sets of tables and diagrams for the project's entrepreneurs and investors. These tools cover all financial and operational considerations which need to be taken into account at the planning stages such as investments analysis, costs verifications and expected expenses breakdowns. As illustrated in FIG. 2, the planning module 100 enables users to quantify the predicted costs and build detailed budgets for different project scenarios 105 using the system's library of categories 200. In addition to costs calculations 210, for each scenario 105 the tool also includes estimations for all needed resources 220, overall project duration and operational complexity 230 according to the specified selections of the user. The operational complexity 230 is calculated according to the estimations of the different types of materials, human resources and the duration of the specific plan.

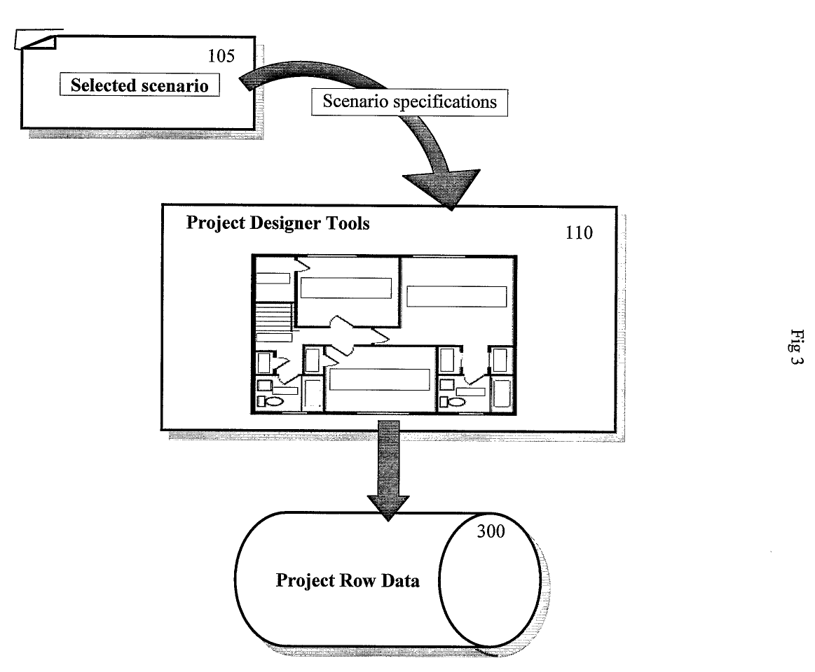

FIG. 3 is a block diagram illustrating the flow of information during the planning stages. The project specifications are given to the project designing team according to the specifications of the selected scenario 105. The designing team produces the project plans 110 in accordance with said specifications. From the plans 110 the system extracts row data 300 in a semi-automatic manner. As the plan of a given area in the building is received from the designer, the management tool administrator imports the plan into the tool and saves it as an image. Next, the administrator identifies the significant components of the plan on the image file. Using the management tool's object library, the administrator marks their positions, traits and any other relevant information.

First, all the external and internal walls of each unit are marked. This stage allows the tool to define the boundaries of the unit and perform initial calculations regarding the area in question. Next, all the openings may be identified and their specifications defined. Then the administrator marks on the image of the plan all the other components and their specifications, such as the details of the plumbing, electricity and the like.

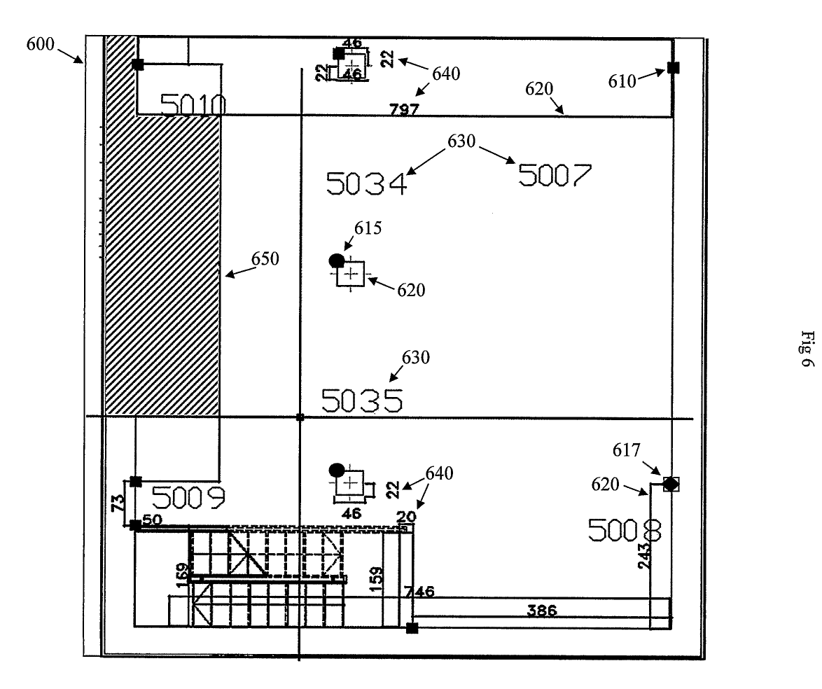

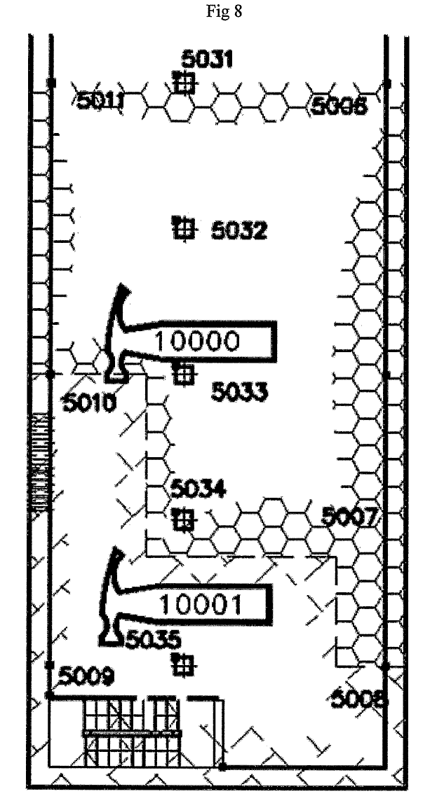

FIG. 6 is an example for a marked plan illustrating the principles of extracting data from a drawing in accordance with the present invention. The items in plan 600 are marked by different geometrical shapes which represent different types of information. The correlation between the shapes and the information they represent is arbitrary and may be determined differently for each project according to its needs. Lines 620, which indicate distances 640, are marked by their end-shape, such as a square 610, a circle 615 or a diamond 617. The line marked with a square 610 may represent a specific type of wall, the diamond 617 marked line may represent a specific type of opening, such as a window, and the line marked with a circle 615 may represent a different type of constructed element, such as a supporting pillar. In addition, an area may be marked 650 indicating that a specific type of work needs to be done there. All the specified elements are given a numeric unique code 630. FIG. 8 is an additional example of a marking method of plans. This figure clearly illustrates a method for marking areas on the plan for the purpose of designating a particular task for that area.

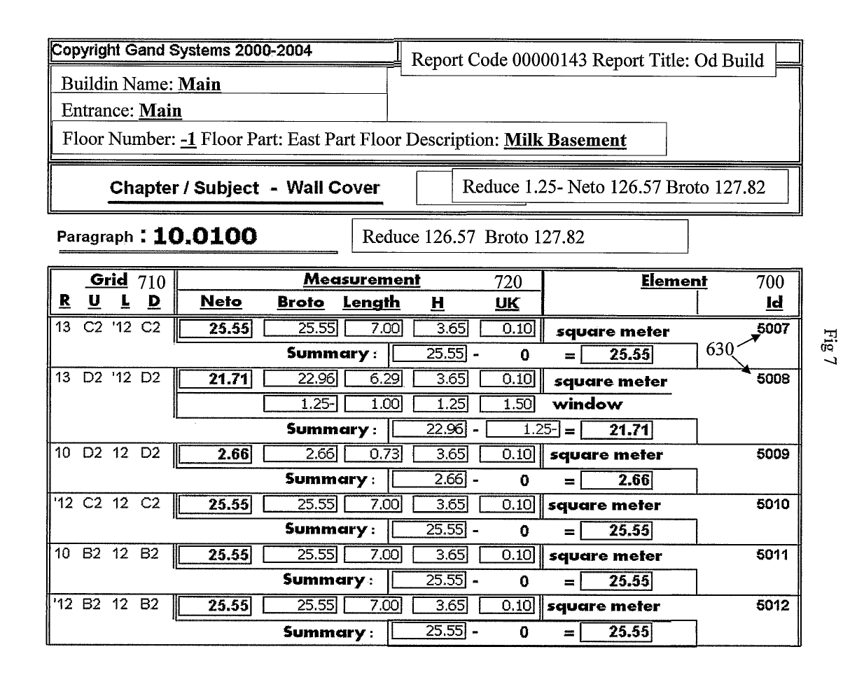

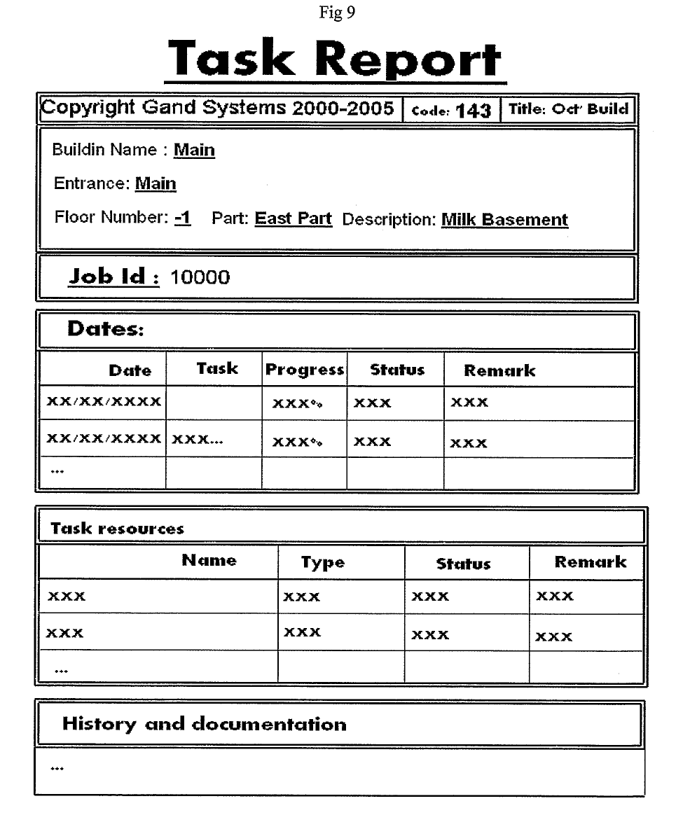

FIG. 7 is a screenshot illustrating the tabular representation of the row data extracted from the drawing. The Id column 700 holds the unique code 630 of each marked element in the plans and the rest of the columns present the relevant data which is derived from the plans such as its relative position 710 and its calculated measurements. FIG. 9 is a screenshot of a Task Report. The Task Report lists all the information about the tasks, such as task details, task status and dates, and specifies the related necessary resources for the task.

Referring back to FIG. 3, it is clear that the tool then automatically extracts the Row Data 300 from the drawings. The Row Data 300, then includes all the elements which were identified and marked on the drawings, and their detailed specifications, as mentioned above. The link between these elements and the row data is a bidirectional link which allows continuous update of the drawings 110 as well as of the Row Data 300. If, for instance a specific element is changed at the level of the Row Data 300, it may be appropriately updated in the drawings 110, and vice versa. This feature of the system allows keeping both the graphic representation of the project and the data constantly up to date at all stages of the project as changes are made.

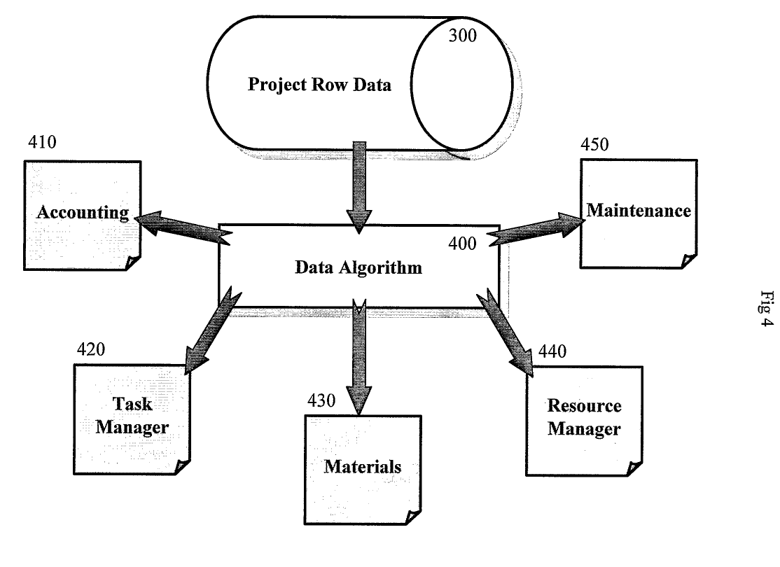

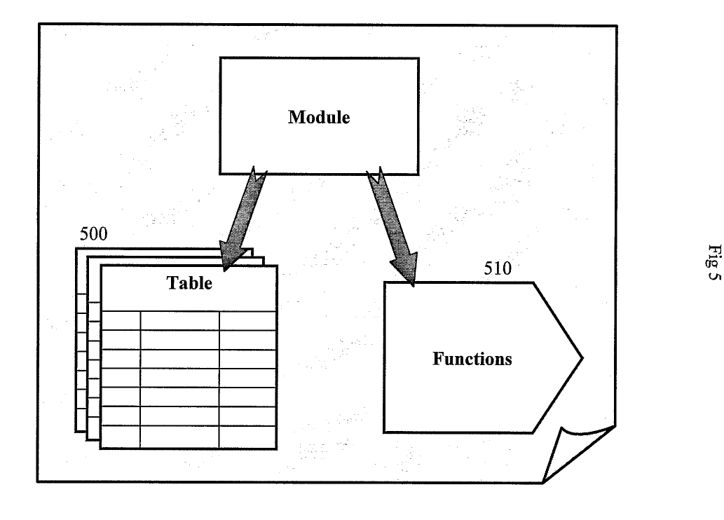

Next, the row data is processed by the system in order to produce the information needed for the project. FIG. 4 is a block diagram illustrating the On Site Project Manager Tools 120 in which this procedure is performed. The information in the Row Data 300 is processed by the Data Algorithm 400. The Data Algorithm 400 analyzes the information and sends it to the different modules. The logical structure of the modules is illustrated in FIG. 5. Each module includes the tables of data 500 and functions 510, whereas the functions 510 are the possible action items which may be executed on the data in the tables 500.

As illustrated in FIG. 4, the modules may include, for instance, an Accounting Module 410, a Task Manager Module 420, a Materials Module 430, a Resource Manager Module 440, and a Maintenance Module 450. The Task Manager Module 420 includes all information about the work tasks which need to be carried out, their schedules and their updated status. The Accounting Module 410 holds the information of all planned and executed financial transactions, including generating outgoing invoices and receipts and registering all incoming invoices and receipts. Modules which are not directly connected to the project management but which may be derived from the data may also be included. Such modules may include, for instance, an asset registration module and an asset management module. The On Site Project Manager Tools 120 may also interface with other applications and tools and share its data by importing and exporting information.

The project management module 120 facilitates the project's decision making stage and operational coordination of the project execution. After all the data from the planning stages is extracted, the system allows the project managers to efficiently make the necessary decisions regarding the project executions, such as comparing prices and bids and planning schedules. The system can also automatically issue work and material orders.

Extensive managerial tools are available for the project coordinator as the project is carried out. These tools allow the users to dynamically update the project's progress and receive an accurate representation of the project situation in real-time. The user may, for instance, dynamically compare the planned budget with the actual accumulated costs, follow the progress of the work and compare it to the predefined schedules, receive constant updates about the raw materials' inventory and calculate usages efficacy of materials, machinery and human resources. The operational coordination tools may run on laptop computer or PDAs and receive information inputs in any electronic format.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claim:

1. A system for managing building project enabling to translate building plans and design into operative resources lists including a list of required materials and required work hours, said system is comprised of:
design converter module wherein the design converter module enable to extract from the building plans and design required relevant raw data for calculating operative resources lists;
a planning module and real time project tracking module, wherein these modules calculation outputs are based on said extracted data.

2. The system of claim 1 further providing budget planning and scheduling basing its calculations on

3. The system of claim 1 wherein the real time project tracking module enable to keep track of the project's progress and dynamically update cost and schedule calculation.

4. The system of claim 1 wherein the drawings are extracted from computer aided designs.

5. The system of claim 1 wherein the drawings are extracted from scanned designs.

6. The system of claim 1 wherein the planning module provides decision making by enabling to compare the costs and resources needed for the planned project according to different scenario plans.

7. The system of claim 6 wherein the different scenario are derived from estimations of the different types of materials, human resources and the duration of the specific plan.

8. The system of claim 1 wherein converter module is operated in accordance with following steps: identifying and marking the significant elements of the plan, defining the boundaries of the elements, performing initial calculations regarding the area of the elements, extracting row data from the marked elements, said raw data including detailed specifications, quantities and components types.

9. The system according to claim 1 wherein the link between the specification drawings objects and the row data is a bidirectional link enabling continuous update of the drawings.

10. The system of claim 10 wherein the bidirectional link maintain both the graphic representation of the project and the raw data constantly up to date at all stages of the project as changes are made.

11. The system of claim 1 further comprising an accounting module, a task manager module, a materials module, a resource manager module and a maintenance module.

12. The system of claim 1 further comprising an asset registration module and an asset management module wherein the costs for these module are calculated on the basis of the raw data.
